(19) United States
(12) Patent Application Publication
(10) Pub. No.: US 2015/0195494 A1
(43) Pub. Date: Jul. 9, 2015

(54) SMARTPHONE INFANT MONITOR

(71) Applicant: Randy Alvarez, La Vernia, TX (US)

(72) Inventor: Randy Alvarez, La Vernia, TX (US)

(21) Appl. No.: 14/146,912

(22) Filed: Jan. 3, 2014

(51) Int. Cl. H04N 7/18

(52) U.S. Cl. CPC H04N 7/183

(57) ABSTRACT

A smartphone infant monitor comprising a monitor, where the monitor includes a housing positioned near a child; a camera lens on the monitor; a touchscreen on a front face of the monitor, where the touchscreen displays an image and operates a plurality of functions associated with the monitor; a signal sent from the monitor to a smartphone, where the signal provides two way communication between the monitor and the smartphone; an interface screen displayed on the smartphone, where the interface screen enables the user to operate a plurality of functions on the monitor; and a securing means attached to a backside of the housing, where the securing means positions the monitor at a desired location near the child.

### BACKGROUND OF THE INVENTION

1. Field of the Invention

The present invention relates to an infant monitor that connected to a smartphone to enable a user to have a two-way communication line to the infant.

2. Description of Related Art

Baby monitors are a staple in most babies' rooms to allow their parents or guardians to keep an eye on the child while they are in another room. The basic monitors receive sound signals from within the room to let the parent listen for when the child cries or fusses. This way the parent can attend to the baby as soon as they are needed. More advanced monitors include cameras with a display screen to allow the parent to also view their child in the other room. These types of monitors provide additional safety measures by allowing the user to ensure that the child is in their bed, that no body parts are stuck in the crib, that a blanket is not over their face or that the child is not getting sick in bed. Still even more advancements have been made with baby monitors like a sensor mat which monitors the baby's breathing. If there is a disruption in their breath or the baby's breath stops an alarm is sounded to alert the user to check on the baby.

Most people carry a cell phone or smartphone with them at all times. Recently, some infant monitors have been modified to communicate with the smartphones. The parent is able to use the smartphone as the display means to watch and listen to the baby. A problem with the smartphone display is that the parent is only able to receive the input from the monitor. They cannot communicate with the child from where they are to possibly instruct the child to lay back down, sing them a lullaby, or play music. The parent must go into the room to instruct or calm the child, which is difficult or impossible when they are away from the house.

Therefore it would be beneficial in the art to provide a monitor that communicates with a smartphone but also allows the user to talk through the smartphone to the monitor. It would also be desirable in the art for the smartphone to monitor and control more than one monitor at once.

### SUMMARY OF THE INVENTION

In view of the foregoing disadvantages inherent in the prior art, the general purpose of the present invention is to provide a monitor used and operated by a smartphone, configured to include all of the advantages of the prior art, and to overcome the drawbacks inherent therein.

Accordingly, an object of the present invention is to an infant monitor that provides two-way communications with a smartphone to enable a user to view and hear their child and then communicate with them accordingly.

Another object of the present invention is to provide a smartphone infant monitor that utilizes 3G, 4G, Wi-Fi and Bluetooth® to allow the smartphone to view the monitor.

Yet another object of the present invention is to provide a smartphone infant monitor that allows a smartphone to view and control more than one monitor at a time.

To achieve the above objects, in an aspect of the present invention, a smartphone infant monitor is described comprising a monitor, where the monitor includes a housing positioned near a child; a camera lens on the monitor; a touchscreen on a front face of the monitor, where the touchscreen displays an image and operates a plurality of functions associated with the monitor; a signal sent from the monitor to a smartphone, where the signal provides two way communication between the monitor and the smartphone; an interface screen displayed on the smartphone, where the interface screen enables the user to operate a plurality of functions on the monitor; and a securing means attached to a backside of the housing, where the securing means positions the monitor at a desired location near the child.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a smartphone with a camera interface screen in accordance with an exemplary embodiment of the present invention;

FIG. 2 depicts a front view of a monitor in accordance with an exemplary embodiment of the present invention;

FIG. 3 depicts a back view of a monitor in accordance with an exemplary embodiment of the present invention; and

FIG. 4 depicts a side view of a monitor in accordance with an exemplary embodiment of the present invention.

Like reference numerals refer to like parts throughout the description of several views of the drawings.

### DETAILED DESCRIPTION OF THE DRAWINGS

The present invention relates to an infant monitor that connected to a smartphone to enable a user to have a two-way communication line to the infant. The present invention provides a smartphone infant monitor to give the user the opportunity to monitor their children through their cell phones. The smartphone infant monitor consists of multiple cameras which communicate with the smartphone via 3G, 4G, Wi-Fi and Bluetooth® technology. The user is able to watch the child/infant on their smartphone while in another room or even away from home. The cameras include screens themselves to allow the user to project their own image and voice to the child. With the smartphone infant monitor the user is afforded a way to watch their child and communicate with them from a remote location.

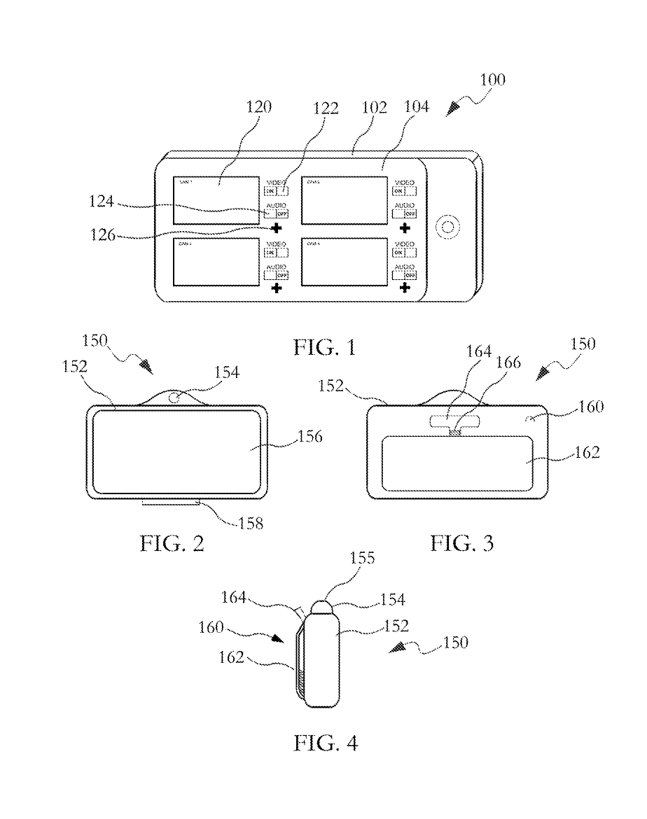

Turning now descriptively to the drawings, FIG. 1 depicts a perspective view of a smartphone 100 with a camera interface screen 104 in accordance with an exemplary embodiment of the present invention. The smartphone 100 may utilize an app that displays on a front screen 102 of the smartphone 100. The app receives a signal from a remote monitor to allow the user to view, hear and interact with their child. When the app is opened on the screen 102 a camera control/interface screen 104 is shown. The camera control screen 104 may display one or more cameras 120 used while monitoring a child. The control screen 104 may display and enable control of up to six cameras 120.

The control screen 104 displays a plurality of control options 122, 124 for each camera 120, one for video control 122, audio control 124 and angle control 126. These control options enable the user to listen to the child, turn on specific cameras, and adjust the camera angle viewing the child in case they move. The interface screen 104 also includes options that allow the user to select a specific camera and only show that camera's display. The user may speak into the smartphone 100 and their voice will sound through the camera with the child. This way the user may communicate with the child in order to soothe, instruct, or sing to them. Audio options of playing songs from a playlist, previously recorded lullabies and white noise is available to the user with the control screen 104. The smartphone 100 may take photos and record videos of the images displayed on the screen 102. The user may also take a photo or video and send that to the monitor.

Referring now to FIG. 2, a front view of a monitor 150 is shown in accordance with an exemplary embodiment of the present invention. The monitor 150 includes a housing 152 that may be attached to or placed on furniture nearby the child. The housing 152 may be plastic for extra durability in case dropped or handled by the child. The housing 152 includes a camera lens 154 positioned at a top portion of the housing. The camera lens 154 enables infrared night vision options to allow viewing the child at night while they are sleeping.

The camera lens 154 may be positioned above a touchscreen 156. The touchscreen 156 enables the user to manipulate the functions of the camera 154. A mic/speaker 158 may be attached to the housing 152. The mic/speaker 158 picks up the noises made by the child and any accessory sound in their room to play back on the smartphone 100. The speaker 158 projects songs, voices, white noise and the like. The user may operate the monitor 150 with the touchscreen 156 which allows for selection of playing a video, displaying an image, playing sounds and communicating with the control interface on the smartphone.

Referring to FIG. 3, a back view of the monitor 150 is shown in accordance with an exemplary embodiment of the present invention. The housing 152 includes a securing means 160 to position the monitor 150 in the desired the location. The securing means 160 may be a combination clip and stand. The securing means 160 includes a brace 162 positioned against the backside of the housing 152, and a handle 164 which moves the brace 162 on a pivot 166. When the handle 164 is pressed the brace 162 extends from the backside of the housing 152. The pivot 166 may include a lock to maintain the brace 162 in an extended position to serve as a stand for the housing 152. This way the monitor 150 may be placed on a bed stand, dresser, shelf, TV or the like. Alternatively, the pivot 166 may include a spring which allows the brace 162 to maintain tension like a clip. This way the monitor 150 may be clipped to the rails of a crib, bed, light or other structure.

Referring to FIG. 4, a side view of the monitor 150 is shown in accordance with an exemplary embodiment of the present invention. The camera lens 154 is illustrated within a protective cover 155 to ensure that the camera lens 154 does not break if the housing 152 is dropped. The securing means 160 is illustrated with the brace 162 against the backside of the housing 152.

The monitor communicates with the smartphone remotely via 3G and 4G technology. When the smartphone is close enough to the monitor Wi-Fi or Bluetooth® may be used. The user is able to watch multiple monitors at once on their smartphone to check on their child(ren) even when they are in another room or away from the house. The user is not only able to view and hear their child, but they can also communicate with them or play noises while they are away. The user may also take pictures or record small videos of themselves and send these to the child which are then displayed on the touchscreen of the monitor. The monitors are easily positioned and moved to any location desired by the user. With the smartphone infant monitor the parent is able to keep an eye on their child, interact with them and afforded peace of mind that their child is safe while they are away.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A smartphone infant monitor comprising:
a. a monitor, where the monitor includes a housing positioned near a child;
b. a camera lens on the monitor;
c. a touchscreen on a front face of the monitor, where the touchscreen displays an image and operates a plurality of functions associated with the monitor;
d. a signal sent from the monitor to a smartphone, where the signal provides two way communication between the monitor and the smartphone;
e. an interface screen displayed on the smartphone, where the interface screen enables the user to operate a plurality of functions on the monitor; and
f. a securing means attached to a backside of the housing, where the securing means positions the monitor at a desired location near the child.

2. The smartphone infant monitor according to claim 1, where the smartphone receives the signal from more than one monitor.

3. The smartphone infant monitor according to claim 1, where the interface screen on the smartphone controls an audio and video controls of the monitor.

4. The smartphone infant monitor according to claim 1, where the interface screen controls the camera angle of the camera lens.

5. The smartphone infant monitor according to claim 1, where the signal is sent from the monitor to the smartphone via one of at least 3G, 4G, Wi-Fi and Bluetooth® technology.

6. The smartphone infant monitor according to claim 1, where the monitor includes a mic/speaker attached to the housing.

7. The smartphone infant monitor according to claim 1, where the securing means is a combination clip/stand, where the combination clip stand includes:
a. a brace against a backside of the housing; and
b. a handle attached to the brace by a pivot, where the handle moves the brace about the pivot to extend the brace from the housing.

8. The smartphone infant monitor according to claim 1, where the camera lens is enveloped within a protective cover.

9. The smartphone infant monitor according to claim 1, where the signal sends pictures, videos and the user's voice from the smartphone to the monitor.
